(19) United States
(12) Patent Application Publication
(10) Pub. No.: US 2004/0259975 A1
(43) Pub. Date: Dec. 23, 2004

(54) System and method for forming photobleachable ink compositions

(76) Inventor: Jean J. Robillard, Guanajuato (MX)

Correspondence Address: ROSENBERG, KLEIN & LEE, 3458 ELLICOTT CENTER DRIVE-SUITE 101, ELLICOTT CITY, MD, 21043, US

(21) Appl. No.: 10/463,333

(22) Filed: Jun. 18, 2003

(51) Int. Cl. C03C 17/00; C09D 5/00

(52) U.S. Cl. 523/160; 523/161

(57) ABSTRACT

A photobleachable ink composition is provided. The photobleachable ink composition includes a photopolymerizable vehicle, which is convertible to solid phase upon exposure to radiation, a photochromic dye, an inorganic or organic metallic salt, and a sensitizer. The photochromic dye is chosen from the spiropyran family and the sensitizer is chosen to accelerate the photobleaching rate of the spiropyran complex. The photobleachable ink compositions may be used to render text and other graphics invisible when exposed to visible light. The photobleachable ink compositions may be prepared in a variety of colors, thus allowing for the creation of multi-colored patterns, with each color composition being bleachable independent of the other colored compositions.

### BACKGROUND OF THE INVENTION

1. Field of the Invention

The subject invention relates to a method and composition for forming photobleachable ink compounds. In particular, the present invention directs itself to a photobleachable ink composition formed from a photopolymerizable vehicle, a photochromic dye, a metallic salt compound, and a sensitizer used to accelerate a photobleaching rate of the ink. More particularly, this invention directs itself to the formation of a printed ink which is bleachable under the application of radiation.

Additionally, the present invention directs itself to a process for printing patterns of ink on textiles and paper. The patterns may be multi-colored and, particularly, each individual color of ink may be bleached separately from the other colored inks.

2. Prior Art

Photosensitive ink compounds are well-known in the art. In general, such prior art inks either transform from a colorless ink to a colored ink under the exposure of radiation, or change colors under the exposure of radiation. It is a purpose of the subject invention, however, to provide a photobleachable ink composition which allows for the bleaching of a colored printed ink upon exposure to radiation.

One such prior art composition is shown in U.S. Pat. No. 4,725,527, wherein a photosensitive composition for direct positive color photography is disclosed. The photographic composition provides a non-silver photographic process based on the photo-decomposition of certain metal-organic compounds adsorbed on an organic semiconductor. Upon the application of radiation, the individual grains in the composition transform chromically. However, the composition does not provide for the bleaching of ink upon the application of radiation.

In another such prior art system, shown in U.S. Pat. No. 3,551,311, radiation-curable compositions are disclosed. These compositions contain an energy-polymerizable polyfunctional ethylenically unsaturated compound which exhibits improved drying speeds. The compositions are curable, or dryable, under the exposure of radiation. They do not, however, vary in color based upon application of radiation.

Another such ink, shown in U.S. Pat. No. 3,673,140, is an actinic radiation curing composition and a method of coating and printing using the same. The disclosed printing inks are cured under the application of radiation, but are not chromically variable.

None of the prior art provides for a combination of elements forming a photobleachable ink composition which allows for the bleaching of ink under the application of radiation.

### SUMMARY OF THE INVENTION

The present invention provides for a photobleachable ink compound and a method for forming the same. The photobleachable ink compound includes a photopolymerizable vehicle, which may be a thermoplastic polymer. Additionally, the compounds include a photochromic dye of the spiropyran family, an inorganic or organic metal salt, which is used as a complexing agent, and a sensitizer which is used to accelerate the photobleaching rate of the spiropyran complex. Under application of radiation, the photobleachable ink compound is bleached and, thusly, loses its pigmentation. Additionally, subsequent application of radiation may be used for curing of the ink compound.

It is a principle objective of the subject photobleachable ink composition to provide a photobleachable ink compound having photochromic dyes, complexing metal salts, and sensitizers.

It is an important objective of the present invention to provide a photobleachable ink composition having a photopolymerizable vehicle convertible to a solid phase responsive to exposure to radiation.

It is a further objective of the subject invention to provide a photobleachable ink composition having a photochromic dye chosen from the group consisting of spiropyran and spirooxazine.

It is a further object of the subject photobleachable ink composition to provide a printed ink containing a metallic salt and a sensitizer.

It is a further objective of the subject invention to provide a method of drying a photobleachable ink composition where the photobleachable ink composition is exposed to radiation.

It is a further object of the subject invention to provide a method for bleaching a photobleachable ink composition where the photobleachable ink composition is exposed to visible light.

It is an important objective of the present invention to provide a method for curing a photobleachable ink composition where the photobleachable ink composition is cured by exposure to radiation.

It is a further object of the subject photobleachable ink compositions to provide a printed ink which may be bleached under the application of radiation.

It is a further objective of the subject invention to provide a photobleachable ink composition which may be cured under the application of radiation.

It is an important objective of the present invention to provide a photobleachable ink compound which may be erased under exposure to strong levels of visible light.

It is a further important objective of the present invention to provide a method for printing photobleachable ink compounds on textiles or paper.

It is a further important objective of the present invention to provide a method for printing with multi-colored inks, with each of the colored inks being bleachable separate from the other colored inks.

### DESCRIPTION OF THE PREFERRED EMBODIMENTS

The photobleachable ink compositions provided by the present invention utilize photochromic spiropyrans. The printing ink compositions include four basic components: a vehicle, a photochromic dye, a metal salt complexant, and a sensitizer.

Vehicles which may be used in the photobleachable ink compositions include epoxidized drying oils or semidrying oil acrylates. These materials may be obtained by reacting bisphenol A epichlorohydrin epoxy resins with metacrylic or acrylic acid. The resulting material may be purchased commercially as Shell's Epoxy Acrylate CULR 266-24.

The photopolymerizable vehicle may be a composition of epoxy acrylate, pentaerythritol triacrylate, and benzophenone. The photopolymerizable vehicle may also be an unsaturated polyester dissolved in styrene and benzoyl peroxide or a composition of pentaerythritol triacrylate, a polychlorinated polyphenyl resin and an a-toluene sulfonamide formaldehyde resin. Alternatively, the photopolymerizable vehicle may be a composition of bisphenol A epichloro hydrin epoxy resin, acrylic acid, pentaerythritol triacrylate, and benzophenone.

The complexants used in the ink compositions are mineral or organic metal salts, including: copper (II) nitrate, cobalt (II) chloride, zinc (II) chloride, mercury (II) chloride, tin (II) chloride, barium naphtenate, zinc naphtenate, cobalt naphtenate, lead naphtenate, and antimony (III) trichloride.

The printing ink compositions of the present invention also include sensitizers which are utilized to accelerate the bleaching process. The sensitizers are compounds which promote hydrogenation or the introduction of halogens in the spiro complex and contain groups such as CN—, CNS—, nitro-, carbonyl-, or carboalkoxy-. The sensitizers may further contain double compounds of hyposulfurous acid as sodium formaldehyde sulfo oxalate or catalysts such as vanadium or titanium salts. Other sensitizers can be inorganic or organic semiconductors such as zinc oxide, polydiacetylene, polythiophenes, or polypyrroles.

The sensitizers may be chosen from the following compounds: thiourea, diallylthiourea, diphenylthiourea, naphtylthiourea, dinaphthylthiourea, N N′ diethyl N′ allylthiourea, N hydroxyethyl N′ allylthiourea, phenylaalylthiourea, benzaldoxime, campheroxime, oxalomolybdic acid, sodium formaldehyde sulfo oxalate, cystine, cysteine, zinc oxide, polydiacetylene, polythiophene, and polypyrrole.

Additionally, the photobleachable ink compositions of the present invention can further include conventional ink additives. Examples of such additives are additives to promote slip and to enhance the film properties of the printed substrates, and are well known in the art. Examples of additives to promote slip are low melting microcrystalline waxes such as Ultraflex White Wax produced by the Boreco Wax Company, low melting polyethylene waxes and silicones.

The photochromic dyes used in the photobleachable ink compositions may include indolinospiropyran, benzothiazolinospiropyran, dinaphtospyran, spirooxazinine, spiroindoline-benzopyran, spiroindoline-naphtooxazine, spiro(benzothiazole-benzopyran), dinaphtospyran, spiro(indoline-benzooxazine), and spiro(benzothiazole-benzooxazine).

The method of curing the ink composition is similar to conventional prior art methods, except that all radiations of wavelength above 380 nm are eliminated from the light source through the use of a filter or by using a source which does not emit wavelengths exceeding 380 nm. Convenient light sources for the curing of the ink compositions are medium pressure mercury vapor lamps, such as the Philips HP-100 and the Hanovia L5142-430 used in combination with a filter UG 11 from the Andover Corporation of Salem, Massachusetts, which eliminates visible light.

Additionally, for infrared sensitive compositions, the ink can be thermally cured by exposing the printed substrate to an infrared source such as a 5585 source produced by the Oriel Corporation of Stratford, Conn..

The bleaching of the ink compositions is performed by exposing the printed substrate to a visible light source. A number of sources are applicable, such as quartz tungsten halogen lamps, xenon and mercury arc lamps and lasers. In the latter case, the spiro complex spectral absorption peak in the ink composition should correspond to the complementary wavelength of the laser. The curing and bleaching of the ink composition can be done simultaneously by exposing the printed substrate to a light source comprising both ultraviolet and visible radiations, such as a medium pressure mercury vapor lamp, such as the Philips HP 500 or a Hanovia L5142-430, used without a filter.

For thermally cured inks, the printed substrate will be exposed to a radiation source comprising both infrared and visible radiations, such as a quartz tungsten halogen lamp, either used alone or in combination with a supplemental infrared source, such as a 5585 infrared source produced by the Oriel Corporation of Stratford, Conn..

The sequence of curing and bleaching can be reversed, whereby the bleaching first takes place when the ink is still wet by exposure to a source of visible light, and then cured by subsequent exposure to an ultraviolet source. The same sequence can be applied to a thermally cured ink composition by first exposing the printed substrate to visible light and then to an infrared source.

The photobleachable ink compositions are printed on a substrate and may be cured through the exposure of radiation, either visible light, infrared radiation, or ultraviolet radiation. The inks are bleachable under the application of radiation. Thus, under the application of visible light, infrared radiation or ultraviolet radiation, the inks will become colorless. These photobleachable inks may be used for anti-counterfeiting measures in secure documents, bank notes, sensitive labels, and the like. The bleaching of the ink under exposure to certain forms of radiation will prohibit the reproduction of the secure materials, and will prevent further attempts to reproduce the materials.

The photobleachable inks may be printed on textiles or paper or other similar surfaces which are adapted to receive ink compositions. The various inks may be produced in a variety of colors, thus allowing for the creation of multi-colored patterns on the textiles or paper. Each of the colored inks may be bleached separately from the other colored inks, thus allowing bleaching of only certain portions or colors of an entire multi-colored pattern.

The photochromic dyes that may be utilized in the photobleachable ink compositions include 6 nitro-1′,3′,3′-trimethyl-spiro (2H.1.benzopyran-2,2′-indoline); 8-methoxy-6-nitro (spiro(2H-1-benzopyran-2,2′-indoline); 1′,3′,3′-trimethylspiro-8-nitro-(2H-1 benzopyran-2′,2′-indoline); 1′,3′,3′-trimethyl-6-hydroxyspiro(2H-1-benzopyran-2′,2′ indoline); 1′-isopropyl-5′-chloro-6-nitro-8-methoxy (spiro(2H-1-benzopyran-2,2′-indoline); spiro (2H-1-benzopyran)-2,2′-benzo-1′,3′-dithiol); 1′,3′,3′-trimethylspiro (3H napht[2,1-b][1,4 oxazine-3,2′-piperidine]; 1′,3′,3′-trimethylspiro (3H-naphth[2,1-b][1,4-oxazine-3,2′-piperidine]; 1,3,3-trimethylspiro (indoline-2,3′-[3H]naphth [2,1-b][1,4] oxazine; 1′,3′,3′-trimethylspiro (3H-naphth[2,1-b][1,4] oxazine-3,2′-piperidine]; 6′-indoline-1,3,3-trimethylspiro [indoline-2,3′-[3H]naphth [2,1-b]-[1,4]oxazine]; and 1,3,3-trimethylspiro [indoline-2,3′-[3H]-naphto-[2,1-b]-[1,4]-oxazine]. The photobleachable inks and methods for bleaching and curing the photobleachable inks of the present invention are described in the following examples:

### EXAMPLE I

A blue printing ink was made from the following components:

| | |
|---|---|
| epoxy acrylate | 59.68 g |
| Ultraflex wax (Boreco Wax Co.) | 5.35 g |
| pentaerythritol tetracrylate | 29.50 g |
| benzophenone | 4.47 g |
| Michler's ketone | 0.50 g |
| 6 nitro-1′,3′,3′-trimethyl-spiro | 0.22 g |
| (2H.1.benzopyran-2,2′-indoline) | |
| barium naphtenate (14% Ba) | 0.77 g |
| oxalic acid | 0.01 g |
| diethylallylthiourea | 0.02 g |
| trichloroacetamide | 1.50 g |

The ink was transferred to a paper substrate by offset press and cured by exposure to a Hanovia Mercury Arc Lamp Nr679 through a UG 11 filter from the Andover Corporation of Salem, N.H., at a distance of 40 cm for 0.4 seconds. The printed image was then bleached by exposure to a xenon light source for 2.5 seconds.

### EXAMPLE II

The printing ink composition used is the same as in Example I, except that the oxalic acid and diethylallylthiourea were replaced by 0.5 g of zinc oxide.

### EXAMPLE III

A red printing ink was prepared with the following components:

| | |
|---|---|
| Ludopal P6 (BASF) | 10.55 g |
| benzoyl peroxide | 0.22 g |
| 8-methoxy-6-nitro(spiro(2H-1- | 0.74 g |
| benzopyran-2,2′-indoline) | |
| zinc naphtenate (12% Zn) | 2.64 g |
| Ixan SGA (30% in MEK) (Solvay) | 73.85 g |
| toluene | 10.55 g |
| thiourea | 1.50 g |

The ink was printed by offset on a paper substrate and cured by exposure to a 6575 IR source produced by the Oriel Corporation of Stratford, Conn., through a germanium filter for 10 seconds. The offset printing was subsequently bleached by exposure to a 250 Watt quartz halogen source for 15 seconds at a distance of 40 cm.

### EXAMPLE IV

A blue ink composition was prepared with:

| | |
|---|---|
| Ludopal P6 (BASF) | 10.55 g |
| benzoyl peroxide | 0.22 g |
| 1′,3′,3′-trimethylspiro-8-nitro- | 0.74 g |
| (2H-1 benzopyran-2′,2′-indoline) | |
| barium naphtenate (14% Ba) | 2.64 g |
| Ixan SGA (30% in MEK) (Solvay) | 73.85 g |
| toluene | 10.55 g |
| dioxymethylallylthiourea | 1.06 g |
| acetamide | 0.45 g |

The ink was printed and cured through exposure to a 5585 infrared source made by the Oriel Corporation of Stratford, Conn., at 40 cm through a germanium filter for 10 seconds. The cured ink was subsequently bleached by exposure to a 6281 mercury arc lamp made by the Oriel Corporation for 15 seconds at a distance of 40 cm.

### EXAMPLE V

A red ink was formed with the following components:

| | |
|---|---|
| pentaerythritol triacrylate | 67.00 g |
| Aroclar 1260 (Monsanto Chemical Co.) | 9.75 g |
| Santolite MHP (Monsanto Chemical Co.) | 3.25 g |
| 1′,3′,3′-trimethyl-6-hydroxyspiro | 0.95 g |
| (2H-1-benzopyran-2′,2′indoline) | |
| zinc naphtenate (12% Zn) | 3.75 g |
| diphenylthiourea | 1.34 g |
| oxalic acid | 0.56 g |
| toluene | 13.40 g |

After printing the ink, the ink was cured by exposure to a Hanovia Mercury Arc Lamp Nr679 through a UG 11 filter from the Andover Corporation of Salem, N.H., at a distance of 40 cm for 0.7 seconds. The bleaching was performed by exposure to the same lamp without a filter at a distance of 40 cm for 10 seconds.

### EXAMPLE VI

A blue ink was prepared with the following composition:

| | |
|---|---|
| CUCLR 266-24 (Shell) | 56.30 g |
| 1′-isopropyl-5′-chloro-6-nitro-8-methoxy | 0.57 g |
| (spiro(2H-1-benzopyran-2,2′-indoline) | |
| copper (II) nitrate | 0.81 g |
| toluene | 8.10 g |
| sodium formaldehyde sulfo oxylate | 0.14 g |
| ultraflex wax (Boreco Wax Company) | 4.00 g |
| pentaethritol triacrylate | 25.40 g |
| benzophenone | 4.16 g |
| Michler's ketone | 0.52 g |

After printing, the substrate was exposed to a Hanovia Mercury Arc Lamp 679 with a UG 11 filter produced by the Andover Corporation of Salem, N.H. The visible portion of the spectrum was eliminated and exposure took place for 0.7 seconds at a distance of 40 cm. The ink was bleached by scanning the surface of the print with a 1 Watt HeNe laser beam at a speed sufficient to cover the entire surface of the print at the normal offset speed.

### EXAMPLE VII

A red photobleachable ink composition was prepared with the following components and quantities:

| | |
|---|---|
| epoxidized soja bean oil acrylate | 88.88 g |
| ultraflex wax (Boreco Wax Company) | 10.32 g |
| spiro(2H-1-benzopyran)-2,2′-benzo-1′, | 0.04 g |
| 3′-dithiol | |
| lead naphtenate (30% Pb) | 0.16 g |
| toluene | 0.58 g |
| phenylallylthiosemicarbazide | 0.01 g |

The ink was printed and cured by exposure to a Hanovia Mercury Arc Lamp Nr679 through a UG 11 filter made by the Andover Corporation of Salem, N.H. for one second at a distance of 40 cm. The bleaching occurred by exposure to a quartz halogen lamp type 6334 produced by the Oriel Corporation of Stratford, Conn. at a distance of 40 cm for 6 seconds.

### EXAMPLE VIII

A blue photobleachable ink composition was prepared with the following components and quantities:

| | |
|---|---|
| CUCLR266-24 (Shell) | 56.62 g |
| 1′,3′,3′-trimethylspiro(3H napht[2,1-b] | 0.50 g |
| [1,4 oxazine-3,2′-piperidine] | |
| mercury (II) chloride | 1.92 g |
| phenylallylthiourea | 0.28 g |
| toluene | 7.10 g |
| ultraflex wax (Boreco Wax Company) | 3.10 g |
| pentaethritol triacrylate | 25.90 g |
| benzophenone | 4.16 g |
| Michler's ketone | 0.52 g |

The above composition was printed by offset and cured by exposure to a Hanovia Mercury Arc Lamp Nr679 with a UG 11 filter produced by the Andover Corporation, for one second at a distance of 40 cm. Bleaching was effected through exposure to a quartz halogen lamp type 6334 produced by the Oriel Corporation of Stratford, Conn. at a distance of 40 cm for 5 seconds.

### EXAMPLE IX

A magenta colored photobleachable ink composition was prepared with the following components:

| | |
|---|---|
| pentaethritol triacrylate | 67.00 g |
| Aroclor 1260 (Monsanto Chemical Company) | 9.75 g |
| Santolite MHP (Monsanto Chemical Company) | 3.25 g |
| 1′,3′,3′-trimethylspiro(3H-naphth[2,1-b] | 0.90 g |
| [1,4-oxazine-3,2′-piperidine] | |
| cobalt (II) chloride | 3.57 g |
| oxalomolybdic acid | 0.77 g |
| phenylurea | 2.04 g |
| toluene | 12.72 g |

The ink was printed on a paper substrate by an offset press and further cured by exposure to a Hanovia Mercury Arc Lamp with a UG 11 filter, produced by the Andover Corporation of Salem, N.H., for one second at a distance of 40 cm. Bleaching was effected by exposure to the same lamp without a filter for 12 seconds at the same distance.

### EXAMPLE X

A blue ink was prepared with the following composition:

| | |
|---|---|
| Ixan SGA (30% in MEK) (Solvay) | 73.85 g |
| Ludopal P6 (BASF) | 10.55 g |
| toluene | 10.55 g |
| benzoyl peroxide | 0.22 g |
| 1,3,3-trimethylspiro(3H-naphth[2,1-b] | 0.74 g |
| [1,4] oxazine | |
| barium naphtenate (40% Ba) | 4.22 g |
| dinaphtylthiourea | 0.24 g |

After printing, the ink was thermocured by exposure to an infrared lamp type 6575 produced by the Oriel Corporation of Stratford, Conn., with a germanium filter, at a distance of 40 cm for 15 seconds. Bleaching was performed by further exposure to a 6281 mercury arc lamp produced by the Oriel Corporation, for 12 seconds at 40 cm.

### EXAMPLE XI

The composition was the same as that in Example X, except that the dinaphtylthiourea was replaced by 0.60 g of polydiacetylene.

### EXAMPLE XII

A photobleachable red ink preparation was prepared with the following components:

| | |
|---|---|
| Ixan SGA (30% in MEK) (Solvay) | 74.90 g |
| Ludopal P6 (BASF) | 10.70 g |
| toluene | 10.70 g |
| benzoyl peroxide | 0.22 g |
| 1′,3′,3′-trimethylspiro(3H-naphth[2,1-b] | 0.74 g |
| [1,4] oxazine-3,2′-piperidine] | |
| zinc naphtenate (12% Zn) | 2.68 g |
| benzaldoxime | 0.24 g |

The ink was cured through exposure to a 6575 infrared source produced by the Oriel Corporation of Stratford, Conn., through a germanium filter at a distance of 40 cm for 18 seconds. The bleaching occurred through subsequent exposure to a quartz halogen lamp type 6334 produced by the Oriel Corporation, through a 5 second interval at a distance of 40 cm.

### EXAMPLE XIII

A blue photobleachable ink was prepared with the composition:

| | |
|---|---|
| epoxy acrylate | 59.61 g |
| Ultraflex wax (Boreco Wax Company) | 3.35 g |
| pentaerythritol triacrylate | 29.57 g |
| benzophenone | 4.47 g |
| Michler's ketone | 0.50 g |
| 6′-indoline-1,3,3-trimethylspiro [indoline-2, | 0.06 g |
| 3′-[3H]naphth[2,1-b][1,4]oxazine] | |
| barium naphtenate (40% Ba) | 0.15 g |
| toluene | 0.78 g |
| naphtylthiourea | 0.02 g |
| trichloroacetamide | 1.50 g |

The above ink composition was cured through exposure to a Hanovia Mercury Arc Lamp with a UG 11 filter, produced by the Andover Corporation of Salem, N.H., for one second at a distance of 40 cm. The ink was subsequently bleached under exposure to the same lamp without a filter for 2 seconds at a distance of 40 cm.

### EXAMPLE XIV

This preparation was the same as in Example XIII, except that the naphtylthiourea was replaced by 0.50 g of polythiophene.

### EXAMPLE XV

A blue photobleachable ink was prepared with the following components:

| | |
|---|---|
| Ixan SGA (30% in MEK) (Solvay) | 75.95 g |
| Ludopal P6 (BASF) | 10.85 g |
| toluene | 10.85 g |
| benzoyl peroxide | 0.22 g |
| 1,3,3-trimethylspiro[indoline-2,3′-[3H]- | 0.98 g |
| naphto-[2,1-b]-[1,4]-oxazine] | |
| copper (II) nitrate | 1.09 g |
| campheroxime | 0.24 g |

The ink was cured through exposure to a 6575 infrared source produced by the Oriel Corporation of Stratford, Conn., through a germanium filter at a distance of 40 cm for 7 seconds. The bleaching was effected by subsequent exposure to a quartz halogen lamp type 6334 produced by the Oriel Corporation of Stratford, Conn., for 20 seconds at a distance of 40 cm.

Although this invention has been described in connection with specific forms and embodiments thereof, it will be appreciated that various modifications other than those discussed above may be resorted to without departing from the spirit or scope of the invention. For example, functionally equivalent elements may be substituted for those specifically shown and described, proportional quantities of the elements shown and described may be varied, and in the formation method steps described, particular steps may be reversed or interposed, all without departing from the spirit or scope of the invention as defined in the appended claims.

What is claimed is:

1. A photobleachable ink composition comprising:
(a) a photopolymerizable vehicle convertible to a solid phase responsive to exposure to radiation;
(b) a photochromic dye chosen from the group consisting of spiropyran and spirooxazine;
(c) a metallic salt chosen from the group consisting of zinc (II) chloride, cobalt (II) chloride, copper (II) nitrate, mercury (II) chloride, tin (II) chloride, antimony trichloride, barium naphtenate, cobalt naphtenate, lead naphtenate, and zinc naphtenate; and,
(d) a sensitizer chosen from the group consisting of thiourea, diallylthiourea, diphenylthiourea, naphtylthiourea, dinaphthylthiourea, N N′ diethyl N′ allylthiourea, N hydroxyethyl N′ allylthiourea, phenylaalylthiourea, benzaldoxime, campheroxime, oxalomolybdic acid, sodium formaldehyde sulfo oxalate, cystine, cysteine, zinc oxide, polydiacetylene, polythiophene, and polypyrrole.

2. The photobleachable ink composition as recited in claim 1 wherein said photopolymerizable vehicle comprises epoxy acrylate, pentaerythritol triacrylate, and benzophenone.

3. The photobleachable ink composition as recited in claim 1 wherein said photopolymerizable vehicle comprises an unsaturated polyester dissolved in styrene and benzoyl peroxide.

4. The photobleachable ink composition as recited in claim 1 wherein said photopolymerizable vehicle comprises pentaerythritol triacrylate, a polychlorinated polyphenyl resin and an a-toluene sulfonamide formaldehyde resin.

5. The photobleachable ink composition as recited in claim 1 wherein said photopolymerizable vehicle comprises bisphenol A epichloro hydrin epoxy resin, acrylic acid, pentaerythritol triacrylate and benzophenone.

6. The photobleachable ink composition as recited in claim 1 wherein said photochromic dye is an indolinospiropyran.

7. The photobleachable ink composition as recited in claim 1 wherein said photochromic dye is a benzothiazolinospiropyran.

8. The photobleachable ink composition as recited in claim 1 wherein said photochromic dye is a dinaphtospyran.

9. The photobleachable ink composition as recited in claim 1 wherein said photochromic dye is a spirooxazine.

10. The photobleachable ink composition as recited in claim 1 wherein said photochromic dye is spiroindoline-benzopyran.

11. The photobleachable ink composition as recited in claim 6 wherein said photochromic dye is spiroindoline-naphtooxazine.

12. The photobleachable ink composition as recited in claim 1 wherein said photochromic dye is spiro(benzothiazole-benzopyran).

13. The photobleachable ink composition as recited in claim 1 wherein said photochromic dye is a dinaphtospyran.

14. The photobleachable ink composition as recited in claim 1 wherein said photochromic dye is spiro(indoline-benzooxazine).

15. The photobleachable ink composition as recited in claim 9 wherein said photochromic dye is spiro(benzothiazole-benzooxazine).

16. The photobleachable ink composition as recited in claim 1 wherein said metallic salt is chosen from the group consisting of zinc (II) chloride, cobalt (II) chloride, copper (II) nitrate, antimony (III) chloride, mercury (II) chloride, and tin (II) chloride.

17. The photobleachable ink composition as recited in claim 1 wherein said metallic salt is chosen from the group consisting of the naphtenates of barium, cobalt, zinc, and lead.

18. The photobleachable ink composition as recited in claim 1 wherein said sensitizer is chosen from the group consisting of thiourea, allylthiourea, diallylthiourea, diphenylthiourea, naphtylthiourea, dimethylthiourea, N N′ diethyl N allylthiourea N hydroxyethyl N′ allylthiourea, N′ allylthiourea, phenylallylthiourea.

19. The photobleachable ink composition as recited in claim 1 wherein said sensitizer is formed of benzaldoxime.

20. The photobleachable ink composition as recited in claim 1 wherein said sensitizer is formed of campheroxime.

21. The photobleachable ink composition as recited in claim 1 wherein said sensitizer is oxalomolybdic acid.

22. The photobleachable ink composition as recited in claim 1 wherein said sensitizer is sodium formaldehyde sulfooxalate.

23. The photobleachable ink composition as recited in claim 1 wherein said sensitizer is chosen from the group consisting of zinc oxide, titanium oxide, tin oxide, cerium oxide, zinc sulfide, and zinc selenide.

24. The photobleachable ink composition as recited in claim 1 wherein said sensitizer is chosen from the group consisting of polyvinylcarbazole, polydiacetylene, polypyrrole, polythiophene, polysilane, polyferrocenylsilane.

25. A method of drying a photobleachable ink composition comprising the steps of:
(a) preparing a photobleachable ink composition having a photopolymerizable vehicle, a photochromic dye, a metallic salt, and a sensitizer; and,
(b) exposing said photobleachable ink composition to radiation.

26. The method of drying a photobleachable ink composition as recited in claim 26 wherein said exposure step utilizes ultraviolet radiation.

27. The method of drying a photobleachable ink composition as recited in claim 26 wherein said preparation step includes the step of selecting said photopolymerizable vehicle comprising epoxy acrylate, pentaerythritol triacrylate and benzophenone.

28. The method of drying a photobleachable ink composition as recited in claim 26 wherein said preparation step includes the step of selecting said photopolymerizable vehicle comprising pentaerythritol triacrylate, a polychlorinated polyphenol resin and an a-toluene sulfonamide formaldehyde resin.

29. The method of drying a photobleachable ink composition as recited in claim 26 wherein said preparation step includes the step of selecting said photopolymerizable vehicle comprising bisphenol A epichloro hydrin epoxy resin, acrylic acid, pentaerythritol triacrylate and benzophenone.

30. The method of drying a photobleachable ink composition as recited in claim 25 wherein said step of exposure utilizes infrared radiation.

31. The method of drying a photobleachable ink composition as recited in claim 30 wherein said preparation step includes the step of selecting said photopolymerizable vehicle comprising an unsaturated polyester dissolved in styrene and benzoyl peroxide.

32. A method of bleaching a photobleachable ink composition comprising the steps of:
(a) preparing a photobleachable ink composition having a photopolymerizable vehicle, a photochromic dye, a metallic salt, and a sensitizer; and,
(b) exposing said photobleachable ink composition to visible light.

33. The method of bleaching a photobleachable ink composition as recited in claim 32 wherein said preparation step includes the step of selecting said photopolymerizable vehicle comprising bisphenol A epichloro hydrin epoxy resin, acrylic acid, pentaerythritol triacrylate and benzophenone.

34. A method of simultaneously curing and bleaching a photobleachable ink composition comprising the steps of:
(a) preparing a photobleachable ink composition having a photopolymerizable vehicle, a photochromic dye, a metallic salt and a sensitizer; and,
(b) exposing said photobleachable ink composition to radiation.

35. The method of simultaneously curing and bleaching a photobleachable ink composition as recited in claim 34 wherein said exposure step utilizes ultraviolet and visible radiation.

36. The method of curing and bleaching a photobleachable ink composition as recited in claim 35 wherein said preparation step includes the step of selecting said photopolymerizable vehicle comprising epoxy acrylate, pentaerythritol triacrylate, and benzophenone.

37. The method of simultaneously curing and bleaching a photobleachable ink composition as recited in claim 35 wherein said preparation step includes the step of selecting said photopolymerizable vehicle comprising pentaerythritol triacrylate, a polychlorinated polyphenol resin and an a-toluene sulfonomide formaldehyde resin.

38. The method of simultaneously curing and bleaching a photobleachable ink composition as recited in claim 35 wherein said preparation step includes the step of selecting said photopolymerizable vehicle comprising bisphenol A epichloro hydrin epoxy resin, acrylic acid, pentaerythritol triacrylate and benzophenone.

39. The method of simultaneously curing and bleaching a photobleachable ink composition as recited in claim 34 wherein said exposure step utilizes infrared and visible radiation.

40. The method of simultaneously curing and bleaching a photobleachable ink composition as recited in claim 39 wherein said preparation step includes the step of selecting said photopolymerizable vehicle comprising an unsaturated polyester dissolved in styrene and benzoyl peroxide.

41. A method of bleaching and curing a photobleachable ink composition comprising the steps of:
(a) preparing a photobleachable ink composition having a photopolymerizable vehicle, a photochromic dye, a metallic salt, and a sensitizer;
(b) exposing said photobleachable ink composition to visible light to bleach said photobleachable ink composition; and,
(c) exposing said photobleachable ink composition to a source of radiation to cure said photobleachable ink composition.

42. The method of bleaching and curing a photobleachable ink composition as recited in claim 41 wherein said step of exposing said photobleachable ink composition to a source of radiation utilizes ultraviolet radiation.

43. The method of bleaching and curing a photobleachable ink composition as recited in claim 42 wherein said preparation step includes the step of selecting said photopolymerizable vehicle comprising epoxy acrylate, pentaerythritol triacrylate, and benzophenone.

44. The method for bleaching and curing a photobleachable ink composition as recited in claim 42 wherein said preparation step includes the step of selecting said photopolymerizable vehicle comprising pentaerythritol triacrylate, a polychlorinated polyphenol resin, and an a-toluene sulfonomide formaldehyde resin.

45. The method for bleaching and curing a photobleachable ink composition as recited in claim 42 wherein said preparation step includes the step of selecting said photopolymerizable vehicle comprising bisphenol A epichloro hydrin epoxy resin, acrylic acid, pentaerythritol triacrylate and benzophenone.

46. The method for bleaching and curing a photobleachable ink composition as recited in claim 41 wherein said step of exposing said photobleachable ink composition to a source of radiation utilizes infrared radiation.

47. The method for bleaching and curing a photobleachable ink composition as recited in claim 46 wherein said preparation step includes the step of selecting said photopolymerizable vehicle comprising an unsaturated polyester dissolved in styrene and benzoyl peroxide.
